(19) United States
(12) Patent Application Publication
(10) Pub. No.: US 2026/0245797 A1
(43) Pub. Date: Aug. 20, 2026

(54) MULTILAYER ELECTRONIC COMPONENT

(71) Applicant: SAMSUNG ELECTRO-MECHANICS CO., LTD., Suwon-si (KR)

(72) Inventors: Jin Soo PARK, Suwon-si (KR); Chul Soon AHN, Suwon-si (KR); Chung Eun LEE, Suwon-si (KR); Min Woo KIM, Suwon-si (KR)

(73) Assignee: SAMSUNG ELECTRO-MECHANICS CO., LTD., Suwon-si (KR)

(21) Appl. No.: 19/419,298

(22) Filed: Dec. 15, 2025

(30) Foreign Application Priority Data
Feb. 19, 2025 (KR) 10-2025-0021216

(51) Int. Cl. H01G 4/232; H01G 4/30

(52) U.S. Cl. CPC H01G 4/232; H01G 4/30

(57) ABSTRACT

A multilayer electronic component includes a body including a dielectric layer and first and second internal electrodes, the body including first and second surfaces opposing each other, third and fourth surfaces opposing each other, and fifth and sixth surfaces opposing each other, a first external electrode disposed on the third and fourth surfaces, a second external electrode disposed on at least one of the fifth and sixth surfaces. t3 > t1 > t2 where t1 is a distance from a center portion of the third or fourth surface to a surface of the first external electrode, t2 is a distance from an end portion of a first internal electrode closest to the first surface to the surface of the first external electrode, t3 is a distance from an end portion of a first internal electrode closest to the second surface to the surface of the first external electrode.

### CROSS-REFERENCE TO RELATED APPLICATIONS

This application claims benefit of priority to Korean Patent Application No. 10-2025-0021216 filed on February 19, 2025 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a type of multilayer electronic component, is a chip-type capacitor mounted on the printed circuit boards of various types of electronic devices, including video display devices, such as liquid crystal displays (LCDs) and plasma display panels (PDPs), computers, smartphones, and mobile phones, and may be charged with or discharged of electricity. MLCCs have been used as components in various electronic devices due to their compact size, high capacitance, and ease of mounting.

Recently, as electronic products have become smaller and the number of components mounted on electronic products has increased, the area available for mounting MLCCs on printed circuit boards has decreased. Consequently, there is a growing demand for MLCCs exhibiting superior bonding strength to printed circuit boards, even in small areas.

Compared to the existing two-terminal MLCCs, three-terminal MLCCs exhibit superior bonding strength to printed circuit boards. Two-terminal MLCCs have two external electrodes facing each other in a length direction, while three-terminal MLCCs have a separate ground external electrode disposed between two signal external electrodes facing each other in the length direction.

However, when mounting a three-terminal MLCC on a printed circuit board, if the solder excessively rises along the signal external electrodes, the surface tension of the solder may increase, causing cracks in the MLCC or a tombstone defect in which the MLCC tilts and rises from the printed circuit board. Also, due to the shape characteristics of a three-terminal MLCC, the thicknesses of the signal external electrodes and the ground external electrodes have to be appropriately adjusted to improve the bonding strength between the MLCC and the printed circuit board.

### SUMMARY

An aspect of the present disclosure is to provide a multilayer electronic component having excellent bonding strength and mounting stability to a printed circuit board.

However, the object of the present disclosure is not limited to the above-described contents and will be more readily understood when specific embodiments of the present disclosure are described.

According to an aspect of the present disclosure, a multilayer electronic component includes: a body including a plurality of dielectric layers and a plurality of first and second internal electrodes alternately disposed with respective dielectric layers of the plurality of dielectric layers interposed therebetween, the body including first and second surfaces opposing each other in a thickness direction, third and fourth surfaces connected to the first and second surfaces and opposing each other in a length direction, and fifth and sixth surfaces connected to the first to fourth surfaces and opposing each other in a width direction; a first external electrode disposed on each of the third and fourth surfaces and connected to the first internal electrode; and a second external electrode disposed on at least one of the fifth and sixth surfaces and connected to the second internal electrode, wherein t3 > t1 > t2 in which t1 is a distance in the length direction from a center portion of the third or fourth surface in the thickness direction to a surface of the first external electrode, t2 is a distance in the length direction from an end portion of a first internal electrode closest to a first surface, among the plurality of first internal electrodes, contacting the first external electrode to a surface of the first external electrode, and t3 is a distance in the length direction from an end portion of a first internal electrode closest to the second surface, among the plurality of first internal electrodes, contacting the first external electrode to the surface of the first external electrode.

According to another aspect of the present disclosure, a multilayer electronic component includes: a body including a plurality of dielectric layers and a plurality of first and second internal electrodes alternately disposed with respective dielectric layers of the plurality of dielectric layers interposed therebetween, the body including first and second surfaces opposing each other in a thickness direction, third and fourth surfaces connected to the first and second surfaces and opposing each other in a length direction, and fifth and sixth surfaces connected to the first to fourth surfaces and opposing each other in a width direction; a first external electrode disposed on each of the third and fourth surfaces and connected to the first internal electrode; and a second external electrode disposed on at least one of the fifth and sixth surfaces and connected to the second internal electrode, wherein the first external electrode includes a first connection portion disposed on each of the third and fourth surfaces and a first band portion disposed to extend from the first connection portion to portions of the first and second surfaces, and a length of the first connection portion measured on a first internal electrode closest to the first surface, among the plurality of first internal electrodes, is smaller than a length of a center portion of the first connection portion in the thickness direction, and the length of the center portion of the first connection portion in the thickness direction is smaller than a length of the first connection portion measured on a first internal electrode closest to the second surface, among the plurality of first internal electrodes.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure;

FIG. 2 is a cross-sectional view taken along line I-I’ of FIG. 1;

FIG. 3 is a cross-sectional view taken along line II-II’ of FIG. 1;

FIG. 4 is a cross-sectional view taken along line III-III’ of FIG. 1;

FIG. 5 is a cross-sectional view taken along line IV-IV’ of FIG. 2;

FIG. 6 is a cross-sectional view taken along line V-V’ of FIG. 2;

FIG. 7 is a cross-sectional view schematically illustrating a multilayer electronic component according to another embodiment of the present disclosure, corresponding to FIG. 5; and

FIG. 8 is a side view schematically illustrating a mounting board of a multilayer electronic component according to another embodiment of the present disclosure.

### DETAILED DESCRIPTION

Hereinafter, embodiments of the present disclosure will be described in detail with reference to the accompanying drawings. The inventive concept may, however, be exemplified in many different forms and should not be construed as being limited to the specific embodiments set forth herein. Rather, these embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and like numbers refer to like elements throughout the specification, and in the drawings, the thickness of layers, films, panels, regions, etc., are exaggerated for clarity. Also, in the drawings, like reference numerals refer to like elements although they are illustrated in different drawings. Throughout the specification, unless explicitly described to the contrary, the word “comprise” and variations, such as “comprises” or “comprising,” will be understood to imply the inclusion of stated elements but not the exclusion of any other elements.

In the drawings, the X direction may be defined as a thickness (T) direction, the Y direction as a length (L) direction, and the Z direction as a width (W) direction. In the present disclosure, “thickness” may refer to the size in the thickness direction, “length” may refer to the size in the length direction, and “width” may refer to the size in the width direction.

### Multilayer Electronic Component

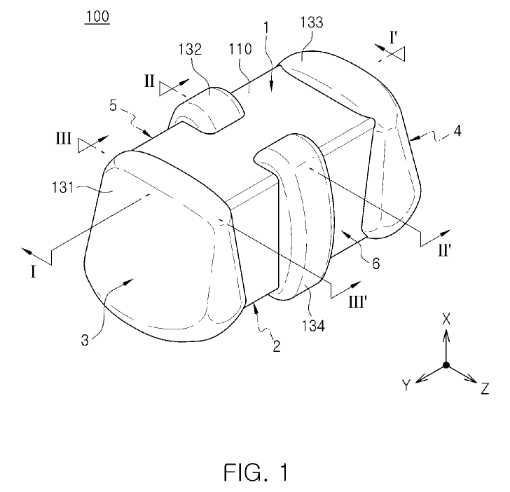

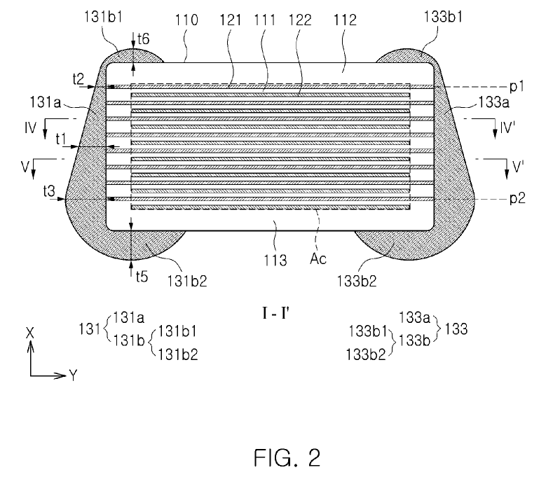

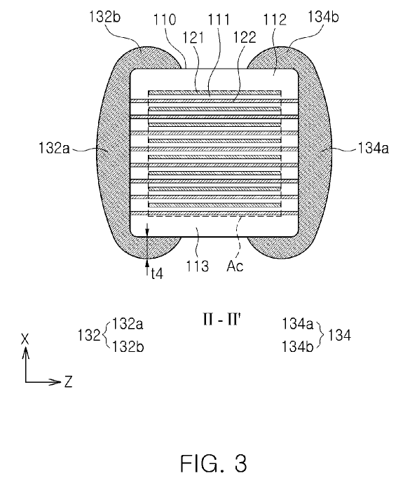

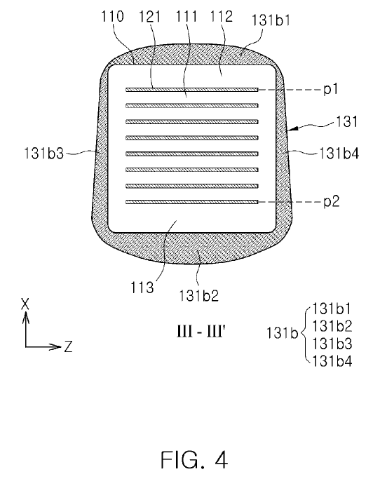

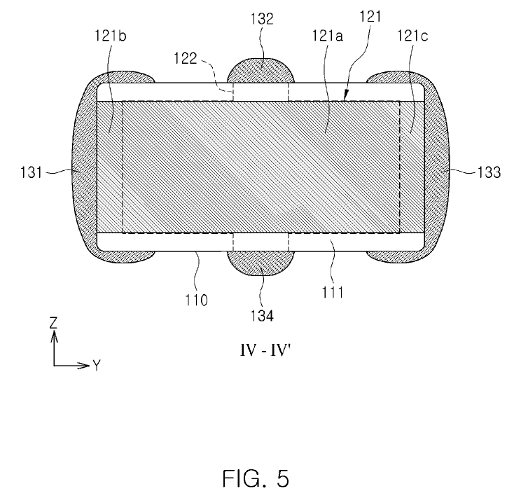

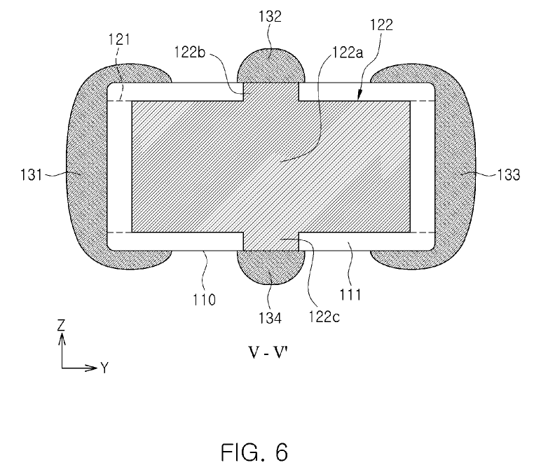

FIG. 1 is a perspective view schematically illustrating a multilayer electronic component according to an embodiment of the present disclosure. FIG. 2 is a cross-sectional view taken along line I-I’ of FIG. 1. FIG. 3 is a cross-sectional view taken along line II-II’ of FIG. 1. FIG. 4 is a cross-sectional view taken along line III-III’ of FIG. 1. FIG. 5 is a cross-sectional view taken along line IV-IV’ of FIG. 2. FIG. 6 is a cross-sectional view taken along line V-V’ of FIG. 2.

Hereinafter, a multilayer electronic component 100 according to an embodiment of the present disclosure will be described in detail with reference to FIGS. 1 through 6. Also, a multilayer ceramic capacitor will be described as an example of a multilayer electronic component. However, the present disclosure is not limited thereto and may be applied to various multilayer electronic components, such as inductors, piezoelectric elements, varistors, or thermistors.

The multilayer electronic component 100 according to an embodiment of the present disclosure may include a body 110 including dielectric layers 111, internal electrodes 121 and 122, and external electrodes 131, 132, 133, and 134.

While there are no particular limitations on the specific shape of the body 110, as illustrated, the body 110 may be formed to have a hexahedral shape or a similar shape. During a sintering process, ceramic powder included in the body 110 may shrink or, due to a polishing process on the corners of the body 110, the body 110 may not be a perfectly straight hexahedron but may have a substantially hexahedron shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth faces 1, 2, 3, and 4 and opposing each other in the width direction.

The plurality of dielectric layers 111 forming the body 110 may be in a sintered state, and adjacent dielectric layers 111 may be integrated such that boundaries therebetween may not be readily apparent without using a scanning electron microscope (SEM).

The dielectric layers 111 may include, for example, a perovskite compound represented by ABO₃ as a main component. The perovskite compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO_{3,} or (Ca₁₋ₓSrₓ)(Zr_{1-y}Ti_{y})O₃ (0<x≤0.5, 0<y≤0.5).

An average thickness of the dielectric layers 111 is not particularly limited. The average thickness of the dielectric layers 111 may range, for example, from 0.1 μm to 20 μm, from 0.1 μm to 10 μm, from 0.1 μm to 5 μm, from 0.1 μm to 2 μm, or from 0.1 μm to 0.4 μm.

The body 110 may include first internal electrodes 121 and second internal electrodes 122 disposed alternately with respective dielectric layers of the dielectric layers 111 interposed therebetween. A region of the body 110 in which the first and second internal electrodes 121 and 122 overlap each other with the dielectric layers 111 interposed therebetween may be defined as a capacitance formation portion Ac. A stacking direction of the internal electrodes 121 and 122 may be the thickness direction or the width direction. The present disclosure will be described based on an embodiment in which the stacking direction of the internal electrodes 121 and 122 is the thickness direction.

The first internal electrodes 121 may include a first main portion 121a overlapping the second internal electrodes 122 in the thickness direction and a pair of first lead portions 121b and 121c extending from the first main portion 121a and exposed to the third and fourth surfaces 3 and 4, respectively.

The second internal electrodes 122 may include a second main portion 122a overlapping the first internal electrodes 121 in the thickness direction, and a pair of second lead portions 122b and 122c extending from the second main portion 122a and exposed to the fifth and sixth surfaces 5 and 6, respectively. However, the present disclosure is not limited thereto, and the second internal electrodes 122 may be exposed to only one of the fifth and sixth surfaces 5 and 6. In this case, the second internal electrode 122 may include only one of the second lead portion 122b exposed to the fifth surface 5 and the second lead portion 122c exposed to the sixth surface 6.

The drawing illustrates a structure in which a size in the width direction (hereinafter referred to as “width”) of the first lead portions 121b and 121c is the same as that of the first main portion 121a. However, the present disclosure is not limited thereto. For example, the width of the first lead portions 121b and 121c may be smaller than that of the first main portion 121a. Alternatively, the width of the first lead portions 121b and 121c may be larger than that of the first main portion 121a. The first lead portions 121b and 121c may also be exposed to the fifth and sixth surfaces 5 and 6. The width of the first lead portions 121b and 121c may gradually increase or decrease from the first main portion 121a toward the third or fourth surfaces 3 and 4.

The drawing illustrates a structure in which a size in the length direction (hereinafter referred to as “length”) of the second lead portions 122b and 122c is smaller than that of the second main portion 122a. However, the present disclosure is not limited thereto. The length of the second main portion 122a may be the same as that of the second lead portions 122b and 122c. In this case, the second internal electrode 122 may have a rectangular shape with the width greater than the length thereof. The length of the second lead portions 122b and 122c may gradually increase or decrease from the second main portion 122a toward the fifth or sixth surface 5 and 6.

A metal may be included in the internal electrodes 121 and 122. The metal may be one or more of Ni, Cu, Pd, Ag, Au, Pt, Sn, W, Ti, and alloys thereof. For example, the metal may include Ni, but the present disclosure is not limited thereto.

An average thickness of the internal electrodes 121 and 122 is not particularly limited. The average thickness of the internal electrodes 121 and 122 may range, for example, from 0.1 μm to 3.0 μm, from 0.1 μm to 1.0 μm, or from 0.1 μm to 0.4 μm.

The average thickness of the dielectric layers 111 and the average thickness of the internal electrodes 121 and 122 may be measured by scanning a cross-section of the multilayer electronic component 100 in the length direction and the thickness direction using a scanning electron microscope (SEM) at 10,000x magnification. More specifically, the average thickness of a single dielectric layer of the dielectric layers 111 may be obtained by measuring the thicknesses at multiple points of the single dielectric layer, for example, five equally spaced points in the length direction and then averaging the measured thicknesses. Also, the average thickness of the internal electrodes 121 and 122 may be obtained by measuring the thicknesses at multiple points of a single internal electrode of the internal electrodes 121 and 122, for example, five equally spaced points in the length direction and then averaging the measured thicknesses. The five equally spaced points may be designated in the capacitance formation portion Ac. Also, by performing these average measurements on ten dielectric layers of the dielectric layers 111 and ten internal electrodes of the internal electrodes 121 and 122 and then averaging the measured values, the average thickness of the dielectric layers 111 and the average thickness of the internal electrodes 121 and 122 may be more generalized.

The body 110 may include cover portions 112 and 113 disposed on both surfaces of the capacitance formation portion Ac opposing each other in the thickness direction. The cover portions 112 and 113 may have a similar configuration to the dielectric layers 111, except that the cover portions 112 and 113 do not include internal electrodes.

The average thickness of the cover portions 112 and 113 is not particularly limited. The average thickness of the cover portions 112 and 113 may be, for example, 150 μm or less, 100 μm or less, 30 μm or less, or 20 μm or less. The average thickness of the cover portions 112 and 113 may be, for example, 5 μm or more, 10 μm or more, or 30 μm or more. Here, the average thickness of the cover portions 112 and 113 refers to the average thickness of each of the first cover portion 112 and the second cover portion 113. The average thickness of the cover portions 112 and 113 may be a value obtained by averaging the thicknesses measured at five equally spaced points in the cross-section of the multilayer electronic component 100 in the length direction and the thickness direction.

The multilayer electronic component 100 may include first external electrodes 131 and 133 disposed on the third and fourth surfaces 3 and 4, respectively, and connected to the first internal electrodes 121. A pair of first external electrodes 131 and 133 may be connected to a pair of first lead portions 121b and 121c on the third and fourth surfaces 3 and 4, respectively. The first external electrodes 131 and 133 may be disposed to extend to portions of the first and second surfaces 1 and 2. In addition, the first external electrodes 131 and 133 may be disposed to extend to portions of the fifth and sixth surfaces 5 and 6. For example, the first external electrode 131 may be disposed on the third surface 3 and extend to portions of the first, second, fifth, and sixth surfaces 1, 2, 5, and 6, and the first external electrode 133 may be disposed on the fourth surface 4 and extend to portions of the first, second, fifth, and sixth surfaces 1, 2, 5, and 6.

The first external electrodes 131 and 133 may include first connection portions 131a and 133a disposed on the third and fourth surfaces 3 and 4, respectively, and first band portions 131b and 133b extending from the first connection portions 131a and 133a to portions of the first and second surfaces 1 and 2. The first band portions 131b and 133b may extend from the first connection portions 131a and 133a to portions of the first, second, fifth, and sixth surfaces 1, 2, 5, and 6.

The multilayer electronic component 100 may include second external electrodes 132 and 134 disposed on at least one of the fifth and sixth surfaces 5 and 6 and connected to the second internal electrodes 122. A pair of second external electrodes 132 and 134 may be connected to a pair of second lead portions 122b and 122c on the fifth and sixth surfaces 5 and 6, respectively. The second external electrodes 132 and 134 may extend to portions of the first and second surfaces 1 and 2. For example, the second external electrode 132 may be disposed on the fifth surface 5 and may extend to portions of the first and second surfaces 1 and 2, and the second external electrode 134 may be disposed on the sixth surface 6 and may extend to portions of the first and second surfaces 1 and 2. However, the present disclosure is not limited thereto, and the second external electrode may be disposed on only one of the fifth and sixth surfaces 5 and 6. In this case, the multilayer electronic component 100 may include only one of the second external electrode 132 disposed on the fifth surface 5 and the second external electrode 134 disposed on the sixth surface 6. Alternatively, the second external electrode 132 disposed on the fifth surface 5 and the second external electrode 134 disposed on the sixth surface 6 may be connected to each other on the first and second surfaces 1 and 2. In this case, the multilayer electronic component 100 may include a single second external electrode continuously disposed on the first, second, fifth, and sixth surfaces 1, 2, 5, and 6.

The second external electrodes 132 and 134 may include second connection portions 132a and 134a disposed on the fifth and sixth surfaces 5 and 6, respectively, and second band portions 132b and 134b extending from the second connection portions 132a and 134a to portions of the first and second surfaces 1 and 2.

The first external electrodes 131 and 133 may be defined as signal external electrodes, and the second external electrodes 132 and 134 may be defined as ground external electrodes.

When the multilayer electronic component is mounted on a printed circuit board, if the solder excessively rises along the first external electrode, for example, if the solder rises to the center of the first external electrode in the thickness direction, the surface tension of the solder may become excessively large, causing cracks in the multilayer electronic component or a tombstone defect in which the multilayer electronic component tilts and rises from the printed circuit board.

In order to solve these problems, in the multilayer electronic component 100 according to an embodiment of the present disclosure, for example, when a distance in the length direction from a center portion of the third or fourth surfaces 3 and 4 in the thickness direction to a surface of the first external electrodes 131 and 133 is t1, a distance in the length direction from an end portion (hereinafter referred to as a first end portion) of a first internal electrode closest to the first surface 1, among the plurality of first internal electrodes 121 contacting the first external electrodes 131 and 133 to the surface of the first external electrodes 131 and 133 is t2, and a distance in the length direction from an end portion (hereinafter referred to as a second end portion) of a first internal electrode closest to the second surface 2, among the plurality of first internal electrodes 121, contacting the first external electrodes 131 and 133 to the surface of the first external electrodes 131 and 133 is t3, then t3 > t1 > t2 may be satisfied.

The t2 may refer to a distance in the length direction from a center portion of the first end portion in the thickness direction to the surface of the first external electrodes 131 and 133, and the t3 may refer to a distance in the length direction from a center portion of the second end portion in the thickness direction to the surface of the first external electrodes 131 and 133.

In the multilayer electronic component 100 according to an embodiment of the present disclosure, for example, a size in the length direction (hereinafter referred to as “length”) of the first connection portions 131a and 133a measured on the first internal electrode closest to the first surface 1 among the plurality of first internal electrodes 121 may be smaller than a length of a center portion of the first connection portions 131a and 133a in the thickness direction, and the length of the center portion of the first connection portions 131a and 133a in the thickness direction may be smaller than a length of the first connection portions 131a and 133a measured on the first internal electrode closest to the second surface 2 among the plurality of first internal electrodes 121.

The length of the center portion of the first connection portions 131a and 133a in the thickness direction, the length of the first connection portions 131a and 133a measured on the first internal electrode closest to the first surface 1 among the plurality of first internal electrodes 121, and the length of the first connection portions 131a and 133a measured on the first internal electrode closest to the second surface 2 among the plurality of first internal electrodes 121 may represent t1, t2, and t3, respectively.

According to an embodiment of the present disclosure, by satisfying t3 > t1 > t2, when the multilayer electronic component 100 is mounted on a printed circuit board, even if the solder does not rise to the center portion of the first external electrodes 131 and 133 in the thickness direction, a sufficient contact area may be provided between the solder and the first external electrodes 131 and 133, thereby improving the bonding strength between the multilayer electronic component 100 and the printed circuit board and preventing cracks or tombstone defects occurring in the multilayer electronic component 100.

In an embodiment, t1 and t3 may satisfy 1.1 ≤ t3/t1 ≤ 1.5. When 1.1 ≤ t3/t1 ≤ 1.5 is satisfied, the bonding strength improvement, crack prevention, and tombstone defect prevention effects of the present disclosure may be more remarkable.

Although t1 and t3 are not particularly limited, they may satisfy 1 μm ≤ t1 ≤ 35 μm and/or 1.1 μm ≤ t3 ≤ 52.5 μm, taking into account the size of the multilayer electronic component 100, the bonding strength with the printed circuit board, or the like.

Referring to FIG. 2, a distance in the length direction from the third or fourth surfaces 3 and 4 to the surface of the first external electrodes 131 and 133 may gradually increase from a first virtual surface p1 parallel to the first internal electrode, among the first internal electrodes 121, closest to the first surface 1 to a second virtual surface p2 parallel to the first internal electrode, among the first internal electrodes 121, closest to the second surface 2, but the present disclosure is not limited thereto. For example, the length of the first connection portions 131a and 133a may gradually increase from the first virtual surface p1 to the second virtual surface p2, but the present disclosure is not limited thereto.

Referring to FIG. 4, a distance in the width direction from the fifth or sixth surface 5 or 6 to the surface of the first external electrode 131 may gradually increase from the first virtual surface p1 parallel to the first internal electrode, among the first internal electrodes 121, closest to the first surface 1 to the second virtual surface p2 parallel to the first internal electrode, among the first internal electrodes 121, closest to the second surface 2, but the present disclosure is not limited thereto. For example, the width of the first band portions 131b3 and 131b4 measured on the fifth surface 5 or the sixth surface 6 may gradually increase from the first virtual surface p1 to the second virtual surface p2, but the present disclosure is not limited thereto.

In an embodiment, when a maximum distance in the thickness direction from the second surface 2 to a surface of the second external electrodes 132 and 134 is t4, and a maximum distance in the thickness direction from the second surface 2 to the surface of the first external electrodes 131 and 133 is t5, t5>t4 may be satisfied. For example, the maximum thickness of the first band portions 131b2 and 133b2 disposed on the second surface 2 may be greater than the maximum thickness of the second band portions 132b and 134b disposed on the second surface 2.

When t5 is greater than t4, when the multilayer electronic component 100 is mounted on a printed circuit board, a phenomenon of the multilayer electronic component 100 tilting, causing the first external electrode 131 disposed on the third surface 3 to be lifted off the printed circuit board or the first external electrode 133 disposed on the fourth surface 4 to be lifted off the printed circuit board, may be suppressed. Accordingly, the bonding strength between the multilayer electronic component 100 and the printed circuit board may be improved.

In an embodiment, when a maximum distance in the thickness from the first surface 1 to the surface of the first external electrodes 131 and 133 is t6, t5 > t6 may be satisfied. For example, the maximum thickness of the first band portions 131b2 and 133b2 disposed on the second surface 2 may be greater than the maximum thickness of the first band portions 131b1 and 133b1 disposed on the first surface 1. That is, the first band portions 131band 133bmay have an asymmetrical shape in which the maximum thickness on the second surface 2 is greater than the maximum thickness on the first surface 1.

The first band portions 131b2 and 133b2 disposed on the second surface 2 may be connected to the solder for physically/electrically connecting the printed circuit board to the multilayer electronic component 100. By satisfying t5 > t6, a sufficient contact area may be provided between the solder and the first external electrodes 131 and 133, thereby improving the bonding strength between the multilayer electronic component 100 and the printed circuit board and reducing the thickness of the first band portions 131b1 and 133b1 disposed opposite to the mounting surface, thereby preventing excessive size increases in the multilayer electronic component 100.

In an embodiment, t3 > t5 may be satisfied. For example, the length of the first connection portions 131a and 133a, measured on the first internal electrode closest to the second surface 2 among the plurality of first internal electrodes 121, may be greater than the maximum thickness of the first band portions 131b2 and 133b2 disposed on the second surface 2. The multilayer electronic component 100, satisfying t3 > t5, may reduce the surface tension of the solder when mounted, thereby more effectively preventing cracking and tombstone defects in the multilayer electronic component 100.

Meanwhile, to further improve the mounting stability of the multilayer electronic component 100 by flattening a mounting surface, t4 and t6 may satisfy t4 > t6. For example, the maximum thickness of the second band portions 132b and 134b disposed on the second surface 2 may be greater than the maximum thickness of the first band portions 131b1 and 133b1 disposed on the first surface 1. However, the present disclosure is not limited thereto.

In an embodiment, t2 and t4 may satisfy t4 > t2. For example, the maximum thickness of the second band portions 132b and 134b disposed on the second surface 2 may be greater than the length of the first connection portions 131a and 133a measured on the first internal electrode closest to the first surface 1 among the plurality of first internal electrodes 121. In addition, t3 and t4 may satisfy t3 > t4. For example, the length of the first connection portions 131a and 133a measured on the first internal electrode closest to the second surface 2 among the plurality of first internal electrodes 121 may be greater than the maximum thickness of the second band portions 132b and 134b disposed on the second surface 2.

The multilayer electronic component 100 may satisfy, for example, each of t3 > t1 > t2, t3 > t5 > t4 > t6, and t3 > t4 > t2, but the present disclosure is not limited thereto.

Hereinafter, an example of a method for measuring t1, t2, t3, t4, t5, and t6 will be described.

First, t1, t2, and t3 may be measured from the cross-section of the multilayer electronic component 100 in the length direction and thickness direction taken from the center portion of the multilayer electronic component 100 in the width direction. t5 and t6 may also be measured from the cross-section of the multilayer electronic component 100 in the length direction and thickness direction taken from the center portion of the multilayer electronic component 100 in the width direction. More specifically, the multilayer electronic component 100 is polished up to the center portion in the width direction to expose the cross-section in the length direction and the thickness direction. After obtaining an image of the end portion of the multilayer electronic component 100 in the length direction, near the first external electrodes 131 and 133, using a scanning electron microscope (SEM) or optical microscope (OM), the image may be analyzed to measure the values t1 to t3, t5, and t6.

For example, t4 may be measured from a cross-section of the multilayer electronic component 100 in the width direction and thickness direction taken from the center portion of the multilayer electronic component 100 in the length direction. More specifically, the multilayer electronic component 100 is polished up to the center portion in the length direction to expose the cross-section in the width direction and the thickness direction. Alternatively, the multilayer electronic component 100 is polished up to the center portion in the width direction to expose the cross-section in the length direction and the thickness direction to measure t1 to t3, t5, and t6, and the polished multilayer electronic component 100 is then polished again up to the center portion in the length direction to expose the cross-section in the width direction and the thickness direction. An image of the end portion of the multilayer electronic component 100 in the width direction is obtained using a scanning electron microscope (SEM) or an optical microscope (OM) and then analyzed to measure t4.

Meanwhile, the type or shape of the external electrodes 131, 132, 133, and 134 is not particularly limited. For example, the external electrodes 131, 132, 133, and 134 may be sintered electrode layers including metal and glass. The metals included in the external electrodes 131, 132, 133, and 134 may include, for example, Cu, Ni, Pd, Pt, Au, Ag, Pb, and/or alloys thereof. The glass included in the external electrodes 131, 132, 133, and 134 may include, for example, one or more oxides of Ba, Ca, Zn, Al, B, and Si.

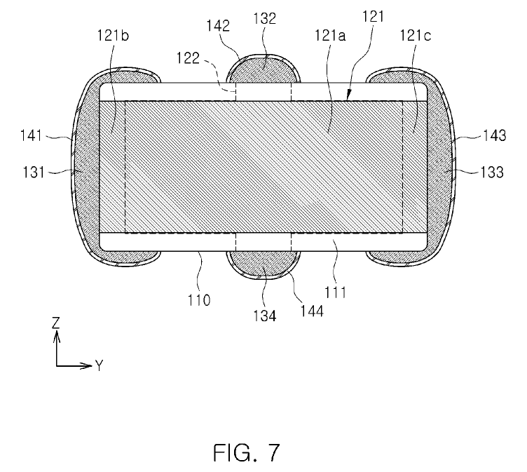

FIG. 7 is a cross-sectional view schematically illustrating a multilayer electronic component according to another embodiment of the present disclosure, corresponding to FIG. 5.

Referring to FIG. 7, first plating layers 141 and 143 may be further disposed on the first external electrodes 131 and 133, and second plating layers 142 and 144 may be further disposed on the second external electrodes 132 and 134.

The first plating layers 141 and 143 and the second plating layers 142 and 144 may serve to improve mounting characteristics. For example, the first plating layers 141 and 143 and the second plating layers 142 and 144 may each include Ni, Sn, Pd, and/or an alloy thereof and may be formed as multiple layers. For example, the first plating layers 141 and 143 and the second plating layers 142 and 144 may each be nickel plating layers or tin plating layers, and the nickel plating layers and tin plating layers may be formed sequentially. The first plating layers 141 and 143 and the second plating layers 142 and 144 may each include multiple nickel plating layers and/or multiple tin plating layers.

The size of the multilayer electronic component 100 is not particularly limited. However, the length of the multilayer electronic component 100 may range from 0.1 mm to 6.0 mm, the width of the multilayer electronic component 100 may range from 0.1 mm to 5.0 mm, and the thickness of the multilayer electronic component 100 may range from 0.05 mm to 3.5 mm.

The length of the multilayer electronic component 100 may be greater than the width and thickness of the multilayer electronic component 100, but the present disclosure is not limited thereto. For example, the length of the multilayer electronic component 100 may be less than the width of the multilayer electronic component 100. The width of the multilayer electronic component 100 may be less than or greater than the thickness of the multilayer electronic component 100 and may vary depending on the specifications or characteristics of the multilayer electronic component 100.

### Method for Manufacturing Multilayer Electronic Component

Hereinafter, an example of a method for forming the multilayer electronic component 100 will be described. However, the method for manufacturing the multilayer electronic component 100 is not limited thereto.

First, ceramic powder for forming the dielectric layers 111 is prepared. The ceramic powder may be perovskite compound powder represented by ABO₃. The ceramic powder may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ)(Zr_{1-y}Ti_{y})O₃ (0<x≤0.5, 0<y≤0.5). BaTiO₃ powder may be synthesized, for example, by reacting a titanium raw material, such as titanium dioxide, with a barium raw material, such as barium carbonate. The method for synthesizing the ceramic powder include, for example, solid-state methods, sol-gel methods, and hydrothermal synthesis, but the present disclosure is not limited thereto. Next, the prepared ceramic powder is dried and pulverized, then mixed with an organic solvent, such as ethanol, and a binder, such as polyvinyl butyral, to prepare a ceramic slurry. The ceramic slurry is applied to a carrier film and dried to form a ceramic green sheet.

Next, an internal electrode conductive paste including metal powder, a binder, an organic solvent, or the like is printed to a predetermined thickness on the ceramic green sheet using a screen printing or gravure printing method to form an internal electrode pattern.

Thereafter, the ceramic green sheet with the internal electrode pattern printed thereon is peeled from the carrier film, and a predetermined number of ceramic green sheets with the internal electrode pattern printed thereon are stacked and compressed to form a ceramic stack. A predetermined number of ceramic green sheets without internal electrode patterns may be stacked on upper and lower surfaces of the ceramic stack to form the cover portions 112 and 113 after sintering. Thereafter, the ceramic stack may be cut to have a predetermined chip size, and the cut chips may be sintered to form the body 110. The sintering may be performed, for example, in a 1.0%H₂/99.0%N₂ ~ 3.5%H₂/96.5%N₂ (H₂O/H₂/N₂ atmosphere) at a temperature of 1000°C or higher and 1400°C or lower for 1 to 3 hours.

Next, the first external electrodes 131 and 133 and the second external electrodes 132 and 134 are formed. For example, the first external electrodes 131 and 133 may be formed by dipping the third and fourth surfaces 3 and 4 into an external electrode conductive paste including metal powder, glass frit, a binder, and an organic solvent and then sintering the external electrode conductive paste at a temperature of 500°C to 900°C. The second external electrodes 132 and 134 may be formed by dipping the fifth and/or sixth surfaces 5 and 6 into the external electrode conductive paste and then sintering the external electrode conductive paste. Alternatively, the first external electrodes 131 and 133 and the second external electrodes 132 and 134 may be formed by transferring the external electrode conductive paste to the third, fourth, fifth, and sixth surfaces 3, 4, 5, and 6 and then sintering the external electrode conductive paste.

Meanwhile, to adjust the shape of the first external electrodes 131 and 133 so as to satisfy t3 > t1 > t2, the body 110 may be brought into close contact with the external electrode conductive paste disposed on a horizontal plane, the external electrode conductive paste is applied to the body 110, and then the body 110 is moved by a predetermined distance in a direction, perpendicular to the horizontal plane, and then the body 110 may be moved in a horizontal direction. Accordingly, the external electrode conductive paste applied to the body 110 may be pushed in a direction, opposite to the movement direction of the body 110. Thereafter, when the external electrode conductive paste applied to the body 110 is dried and fired, the multilayer electronic component may satisfy t3 > t1 > t2. However, the present disclosure is not limited thereto.

Finally, electroplating and/or electroless plating may be performed to additionally form the plating layers 141, 142, 143, and 144 on the external electrodes 131, 132, 133, and 134.

### Mounting Board for Multilayer Electronic Component

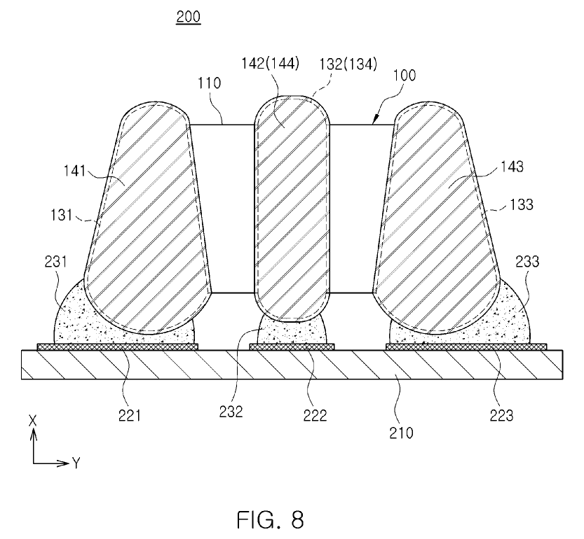

FIG. 8 is a schematic side view of a mounting board for a multilayer electronic component according to another embodiment of the present disclosure.

Hereinafter, a mounting board 200 for a multilayer electronic component according to an embodiment of the present disclosure will be described with reference to FIG. 8. Components the same as or similar to those of the multilayer electronic component 100 described above with reference to FIGS. 1 to 7 are designated by the same or similar reference numerals, and redundant descriptions will be omitted.

Referring to FIG. 8, the mounting board 200 for a multilayer electronic component may include a printed circuit board 210 including electrode pads 221, 222, and 223, the multilayer electronic component 100 disposed on the printed circuit board 210, and solders 231, 232, and 233 connecting the electrode pads 221, 222, and 223 to the multilayer electronic component 100.

The printed circuit board 210 may include, for example, a resin, such as glass epoxy, or a ceramic, such as glass ceramic. The printed circuit board 210 may, for example, have a form in which a plurality of insulating layers are stacked.

The printed circuit board 210 may include first electrode pads 221 and 223 connected to the first plating layers 141 and 143 and a second electrode pad 222 connected to the second plating layers 142 and 144. Although not shown, a pair of second electrode pads 222 may be arranged on the printed circuit board 210 and connected to a pair of second plating layers 142 and 144, respectively.

The solders 231, 232, and 233 may include first solders 231 and 233 contacting the first plating layers 141 and 143 and the first electrode pads 221 and 223, respectively, and a second solder 232 contacting each of the second plating layers 142 and 144 and the second electrode pads 222.

Referring to FIG. 8, in the mounting board 200 of the multilayer electronic component according to an embodiment of the present disclosure, due to the shape of the first external electrodes 131 and 133, the first solders 231 and 233 may not rise up to the center portion of the first external electrodes 131 and 133 in the thickness direction, thereby preventing cracking or tombstone defects in the multilayer electronic component 100.

As one of the various effects of the present disclosure, the multilayer electronic component having excellent bonding strength and mounting stability to a printed circuit board may be provided.

The present disclosure is not limited to the above-described embodiments and the attached drawings but is intended to be defined by the appended claims. Accordingly, various substitutions, modifications, and alterations may be made by those skilled in the art without departing from the technical spirit of the present disclosure as defined in the claims, and such modifications are also considered to fall within the scope of the present disclosure.

The expression “an embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

In the present disclosure, the term “connected” may not only refer to “directly connected” but also include “indirectly connected” by means of an adhesive layer, or the like. Also, the term “electrically connected” may include both of the case in which elements are “physically connected” and the case in which elements are “not physically connected.” In addition, it may be understood that when an element is referred to with “first” and “second,” the element is not limited thereby. They may be used only for a purpose of distinguishing the element from the other elements and may not limit the sequence or importance of the elements. In some cases, a first element may be referred to as a second element without departing from the scope of the claims set forth herein. Similarly, a second element may also be referred to as a first element.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

What is claimed is:

1. A multilayer electronic component comprising:
a body including a plurality of dielectric layers and a plurality of first and second internal electrodes alternately disposed with respective dielectric layers of the plurality of dielectric layers interposed therebetween, the body including first and second surfaces opposing each other in a thickness direction, third and fourth surfaces connected to the first and second surfaces and opposing each other in a length direction, and fifth and sixth surfaces connected to the first to fourth surfaces and opposing each other in a width direction;
a first external electrode disposed on each of the third and fourth surfaces and connected to the first internal electrode; and
a second external electrode disposed on at least one of the fifth and sixth surfaces and connected to the second internal electrode,
wherein t3 > t1 > t2 in which t1 is a distance in the length direction from a center portion of the third or fourth surface in the thickness direction to a surface of the first external electrode, t2 is a distance in the length direction from an end portion of a first internal electrode closest to the first surface, among the plurality of first internal electrodes, contacting the first external electrode to the surface of the first external electrode, and t3 is a distance in the length direction from an end portion of a first internal electrode closest to the second surface, among the plurality of first internal electrodes, contacting the first external electrode to the surface of the first external electrode.

2. The multilayer electronic component of claim 1, wherein
the first and second external electrodes are disposed to extend to portions of the first and second surfaces, respectively, and
t5 > t4 in which t4 is a maximum distance in the thickness direction from the second surface to a surface of the second external electrode and t5 is a maximum distance in the thickness direction from the second surface to the surface of the first external electrode.

3. The multilayer electronic component of claim 2, wherein t4 > t6 in which t6 is a maximum distance in the thickness direction from the first surface to the surface of the first external electrode.

4. The multilayer electronic component of claim 1, wherein
the first external electrode is disposed to extend to portions of the first and second surfaces, and
t5 > t6 in which t5 is a maximum distance in the thickness direction from the second surface to the surface of the first external electrode and t6 is a maximum distance in the thickness direction from the first surface to the surface of the first external electrode.

5. The multilayer electronic component of claim 1, wherein the first external electrode is disposed to extend to portions of the first and second surfaces, and t3 > t5 in which t5 is a maximum distance in the thickness direction from the second surface to the surface of the first external electrode.

6. The multilayer electronic component of claim 1, wherein the second external electrode is disposed to extend to portions of the first and second surfaces, and t4 > t2 in which t4 is a maximum distance in the thickness direction from the second surface to a surface of the second external electrode.

7. The multilayer electronic component of claim 6, wherein t3 and t4 satisfy t3 > t4.

8. The multilayer electronic component of claim 1, wherein t1 and t3 satisfy 1.1 ≤ t3/t1 ≤ 1.5.

9. The multilayer electronic component of claim 1, wherein a distance in the length direction from the third or fourth surface to the surface of the first external electrode gradually increases from a first virtual surface parallel to the first internal electrode closest to the first surface to a second virtual surface parallel to the first internal electrode closest to the second surface.

10. The multilayer electronic component of claim 1, wherein the first external electrode is disposed to extend to portions of the fifth and sixth surfaces, and a distance in the width direction from the fifth or sixth surface to the surface of the first external electrode gradually increases from a first virtual surface parallel to the first internal electrode closest to the first surface to a second virtual surface parallel to the first internal electrode closest to the second surface.

11. The multilayer electronic component of claim 1, wherein t1 satisfies 1μm ≤ t1 ≤ 35μm.

12. The multilayer electronic component of claim 1, wherein t3 satisfies 1.1μm ≤ t3 ≤ 52.5μm.

13. The multilayer electronic component of claim 1, wherein a first plating layer is further disposed on the first external electrode, and a second plating layer is further disposed on the second external electrode.

14. The multilayer electronic component of claim 1, wherein t1, t2 and t3 are measured from a cross-section in the length direction and thickness direction taken from a center portion of the multilayer electronic component in the width direction.

15. A multilayer electronic component comprising:
a body including a plurality of dielectric layers and a plurality of first and second internal electrodes alternately disposed with respective dielectric layers of the plurality of dielectric layers interposed therebetween, the body including first and second surfaces opposing each other in a thickness direction, third and fourth surfaces connected to the first and second surfaces and opposing each other in a length direction, and fifth and sixth surfaces connected to the first to fourth surfaces and opposing each other in a width direction;
a first external electrode disposed on each of the third and fourth surfaces and connected to the first internal electrode; and
a second external electrode disposed on at least one of the fifth and sixth surfaces and connected to the second internal electrode,
wherein the first external electrode includes a first connection portion disposed on each of the third and fourth surfaces and a first band portion disposed to extend from the first connection portion to portions of the first and second surfaces, and
a length of the first connection portion measured on a first internal electrode closest to the first surface, among the plurality of first internal electrodes, is smaller than a length of a center portion of the first connection portion in the thickness direction, and the length of the center portion of the first connection portion in the thickness direction is smaller than a length of the first connection portion measured on a first internal electrode closest to the second surface, among the plurality of first internal electrodes.

16. The multilayer electronic component of claim 15, wherein a maximum thickness of the first band portion disposed on the second surface is greater than a maximum thickness of the first band portion disposed on the first surface.
